(19) United States
(12) Patent Application Publication
(10) Pub. No.: US 2025/0372068 A1
(43) Pub. Date: Dec. 4, 2025

(54) MUSIC COMPOSITION METHOD AND APPARATUS, AND ELECTRONIC DEVICE AND READABLE STORAGE MEDIUM

(71) Applicant: Beijing Zitiao Network Technology Co., Ltd., Beijing (CN)

(72) Inventor: Haoxiang PENG, Beijing (CN)

(21) Appl. No.: 18/876,601

(22) PCT Filed: Oct. 26, 2023
(86) PCT No.: PCT/CN2023/126882

§ 371 Date: Dec. 18, 2024

(30) Foreign Application Priority Data
Oct. 31, 2022 (CN) 202211348849.9

(51) Int. Cl. G10H 1/00; G06T 11/00; G11B 27/031

(52) U.S. Cl. CPC G10H 1/0025; G06T 11/00; G11B 27/031; G10H 2210/111

(57) ABSTRACT

The present disclosure provides a music creating method, an apparatus, an electronic device and a readable storage medium, the method includes: exhibiting a plurality of first audio tracks, wherein each of the plurality of first audio tracks are divided into a plurality of candidate track clips according to a timeline, and each of the plurality of candidate track clips corresponds to one audio clip; determining selected one or more candidate track clips as target track clips and determining that audio clips corresponding to the target track clips are added to positions of the timeline corresponding to the target track clips on the first audio tracks where the target track clips are located, in response to select operations on the one or more candidate track clips among the candidate track clips of the plurality of first audio tracks.

The present disclosure claims priority of Chinese Patent Application No. 202211348849.9 filed on Oct. 31, 2022, the disclosure of which is incorporated herein by reference in its entirety as part of the present disclosure.

### TECHNICAL FIELD

The present disclosure relates to a music creating method, an apparatus, an electronic device and a readable storage medium.

### BACKGROUND

At present, a user still selects background music for posting a short video from a music library of professional singers, but the inventory of songs in the music library is limited. Even if users occasionally have a burst of creative enthusiasm and inspiration, when faced with needs of a series of chains such as organizing a band, purchasing musical instruments, training, rehearsing repeatedly, recording, post-production sound mixing, etc., most users ultimately hesitate without knowing how to start due to such long chains and high costs. Music creation and edition have high barriers, high costs, as well as long and cumbersome chains, which is not favorable for the users to exert inspiration. Therefore, how to lower the barrier for music creation and help a user start creating a piece of music from zero is an urgent problem that needs to be solved.

### SUMMARY

In order to solve the above-described technical problems, the present disclosure provides a music creating method, an apparatus, an electronic device and a readable storage medium.

The present disclosure provides a music creating method, which comprises:
exhibiting a plurality of first audio tracks, in which each of the plurality of first audio tracks are divided into a plurality of candidate track clips according to a timeline, and each of the plurality of candidate track clips corresponds to one audio clip;
determining selected one or more candidate track clips as target track clips and determining that audio clips corresponding to the target track clips are added to positions of the timeline corresponding to the target track clips on the first audio tracks where the target track clips are located, in response to select operations on the one or more candidate track clips among the candidate track clips of the plurality of first audio tracks: in which the audio clips added onto a plurality of target track clips belonging to a same one of the first audio tracks are the same; and the audio clips added onto the target track clips of different first audio tracks are different; and
sound mixing and synthesizing the audio clips added onto the plurality of first audio tracks according to the timeline, in response to a sound mixing instruction, and playing the same.

In some embodiments, before the exhibiting a plurality of first audio tracks, further comprises:
acquiring a music style specified by a user and determining an instrument combination that matches the music style based on the music style specified by the user;
generating the first audio tracks respectively corresponding to respective instruments comprised in the instrument combination, and determining audio clips respectively corresponding to the plurality of candidate track clips on the first audio tracks respectively corresponding to the respective instruments; in which the audio clips respectively corresponding to the plurality of track clips on the first audio tracks are the audio clips of the instruments corresponding to the first audio tracks.

In some embodiments, further comprises: adjusting a position range covered by the target track clips comprised in the plurality of first audio tracks on the timeline, and adjusting a tempo of the corresponding audio clips based on an adjusted position range covered by the target track clips on the timeline, so that a duration of the audio clips matches the adjusted position range covered by the target track clips on the timeline.

In some embodiments, further comprises: generating and exhibiting a newly added first audio track, in response to a trigger operation on a newly added track control, and determining audio clips respectively corresponding to a plurality of candidate track clips of the newly added first audio track.

In some embodiments, further comprises: deleting a first audio track corresponding to a track deletion control, in response to a trigger operation on the track deletion control.

In some embodiments, further comprises: exporting mixed audio data obtained by sound mixing and synthesizing the audio clips on the plurality of first audio tracks in response to an export instruction, and storing the same as an audio file in a specified format.

In some embodiments, further comprises: adding an audio material imported by a user onto a second audio track for sound mixing with the audio clips added onto the first audio tracks; in which a start moment position of a position interval covered by the audio material on the timeline is aligned with a start moment position of the timeline;
sound mixing and synthesizing the audio material on the second audio track and the audio clips on the plurality of first audio tracks according to the timeline in response to the sound mixing instruction, and playing the same.

In some embodiments, after the adding an audio material imported by a user onto a second audio track, further comprises: performing audio processing on the audio material on the second audio track, in which the audio processing comprises one or more of crop, tempo change, tone change and voice change.

In some embodiments, further comprises: synthesizing a custom audio clip with mixed audio data played after a playback moment corresponding to a trigger operation, in response to the trigger operation on the custom audio clip, in the process of playing the mixed audio data obtained by sound mixing and synthesizing the audio clips on the plurality of first audio tracks; and playing synthesized audio data.

In some embodiments, further comprises: acquiring a recorded audio, further synthesizing the recorded audio with mixed audio data obtained by sound mixing and synthesizing the audio clips on the plurality of first audio tracks according to the timeline, and playing synthesized audio data.

In some embodiments, further comprises: acquiring a video material, synthesizing the video material with mixed audio data obtained by sound mixing and synthesizing the audio clips on the plurality of first audio tracks according to the timeline, and playing obtained video data.

In some embodiments, further comprises: performing image processing on the video material to obtain a video material having a target image effect.

The present disclosure provides a music creating apparatus, which comprises:
an exhibiting module, configured to exhibit a plurality of first audio tracks, in which each of the plurality of first audio tracks are divided into a plurality of candidate track clips according to a timeline, and each of the plurality of candidate track clips corresponds to one audio clip;
an audio track processing module, configured to determine selected one or more candidate track clips as target track clips and determine that audio clips corresponding to the target track clips are added to positions of the timeline corresponding to the target track clips on the first audio tracks where the target track clips are located, in response to select operations on the one or more candidate track clips among the candidate track clips of the plurality of first audio tracks; in which the audio clips added onto a plurality of target track clips belonging to a same one of the first audio tracks are the same; and the audio clips added onto the target track clips of different first audio tracks are different;
a synthesizing module, configured to sound mix and synthesize the audio clips added onto the plurality of first audio tracks according to the timeline, in response to a sound mixing instruction;
a playback module, configured to play mixed audio data generated by sound mixing and synthesizing.

The present disclosure provides an electronic device, which comprises: a memory and a processor; in which
the memory is configured to store computer program instructions; and
the processor is configured to execute the computer program instructions to enable the electronic device to implement the music creating method mentioned above.

The present disclosure provides a readable storage medium, which comprises: computer program instructions: in which at least one processor of an electronic device executes the computer program instructions to enable the electronic device to implement the music creating method mentioned above.

The present disclosure provides a computer program product, in which an electronic device runs the computer program product to enable the electronic device to implement the music creating method mentioned above.

The present disclosure provides a music creating method, an apparatus, an electronic device and a readable storage medium, in which in the method, the first audio tracks are divided into a plurality of candidate track clips according to a timeline, and each of the candidate track clips corresponds to one music beat, in addition, correspondence relationships between the plurality of candidate track clips on the first audio tracks and the audio clips are established in advance, so that a user may add audio clips to corresponding music beats by executing a simple select operation on one or more candidate track clips among the plurality of candidate track clips, which facilitates the user to understand and create music; and afterwards, in response to a sound mixing instruction, the audio clips added onto the plurality of first audio tracks are subjected to sound mixing and synthesizing according to the timeline for playback, which allows the user to preview the created audio. Besides, by providing a music creation tool that utilizes an abstract music data model and a digital creation chain to lower threshold for the user to create and edit music, which may perform creation with merely a mobile device, and break the existing hardware device limitations for the existing music creation.

### BRIEF DESCRIPTION OF DRAWINGS

The accompanying drawings, which are hereby incorporated in and constitute a part of the present description, illustrate embodiments of the present disclosure, and together with the description, serve to explain the principles of the embodiments of the present disclosure.

To describe the embodiments of the present disclosure more clearly, the accompanying drawings required in the embodiments will be described briefly below. Apparently, other accompanying drawings can also be derived from these drawings by those ordinarily skilled in the art without creative efforts.

FIG. 1 is a flow chart of a music creating method provided by an embodiment of the present disclosure;

FIG. 2 is a flow chart of a music creating method provided by another embodiment of the present disclosure;

FIG. 3 is a flow chart of a music creating method provided by still another embodiment of the present disclosure;

FIG. 4A to FIG. 4E are schematic diagrams of interactive interfaces provided by an embodiment of the present disclosure;

FIG. 5 is a structural schematic diagram of a music creating apparatus provided by an embodiment of the present disclosure.

### DETAILED DESCRIPTION

To provide a clearer understanding of the objectives, features, and advantages of the embodiments of the present disclosure, the solutions in the present disclosure will be further described below. It should be noted that the embodiments in the present disclosure and features in the embodiments may be combined with one another without conflict.

Many specific details are described below to help fully understand the present disclosure. However, the present disclosure may also be implemented in other manners different from those described herein. Apparently, the embodiments in the specification are merely some rather than all of the embodiments of the present disclosure.

Exemplarily, the present disclosure provides a music creating method, an apparatus, an electronic device, a readable storage medium and a computer program product, in which the present disclosure provides a music creation tool that utilizes an abstract music data model and a digital creation chain to reduce a barrier for a user to create and edit music, and may create a complete piece of music with merely a mobile device. Moreover, the music creation tool adds selections of rhythm, style and timbre on the basis of providing the user with atomic creation capabilities, so that the user may create according to his/her own preference, and at the same time, can migrate hardware device capabilities to software, breaking free from the expensive and heavy hardware device while fully simulating immersive music experience brought by the former, so that the user may create anytime, anywhere. In addition, the music creation tool further provides music remix ability, allowing for secondary creation on the basis of existing works, so as to meet music creation needs of the user. Besides, the music creation tool may automatically initialize corresponding instrument tracks according to a music style selected by the user, so as to match the music style, which further facilitates the user to get started, reduce creation barriers for the user, and provides the user with original creative capabilities to a greater extent. Moreover, the music creation tool further establishes a complete music creation chain, connecting the entire process from 0 to 1 in the creation process, including various nodes such as music creation, voice input (audio recording), real-time video (video recording), special effects rendering, work preview, and work saving, etc., which may comprehensively meet various needs of the user in the creation process, greatly improve creative interests of the user, and make it possible to generalize music creation.

The music creation tool provided by the present disclosure provides a first audio track corresponding to instruments and a second audio track corresponding to remix, and the music creation tool provides functions such as adding free sound effect capabilities, audio recording, audio processing, video recording, image processing, etc., to implement at least several creative capabilities as follows.
1. Atomic creation capability: dividing a composition of music into instrument tracks, timelines, rhythms, and fragment tones. The user may voluntarily select his/her own instruments, rhythms, music styles, etc., and create through simple operations, which greatly reduces barriers for creation, and stimulates the user's interest in creation. Meanwhile, it provides real-time improvisation, for example, electronic sounds and vocal special effects, which may also be easily added during real-time recording.
2. Automatic generation of an instrument combination according to a selected music style: one click solution to an instrument matching problem for the user. For example, if the user wants to create Chinese style music, traditional Chinese instruments such as an erhu, a guzheng and a pipa and so on may be directly matched for the user, to ensure that the user may create music that meets the expected music style.
3. Music remix: music remix refers to secondary creation of existing music, in addition, audio processing capabilities such as tempo change, voice change, and tone change may also be provided for the imported audio materials. The secondary creation not only retains the original music style, but also incorporates the user's understanding and ideas about the work, which greatly stimulates creative potential of the user.
4. Real-time audio/video recording: providing a complete audio/video creation tool, connecting a complete chain from music production, original sound input to audio recording and saving a music video (MV), and meanwhile, further adding video recording and image processing. for example, filter and special effect rendering, etc., which provides a one-stop solution for video/audio creation.

In which, the music creating method according to the present disclosure is executed by the electronic device. The electronic device may be a device such as a tablet computer, a mobile phone (e.g., a folding screen mobile phone, a large screen mobile phone, etc.), a wearable device, a vehicle-mounted device, an augmented reality (AR)/virtual reality (VR) device, a laptop computer, an ultra-mobile personal computer (UMPC), a netbook, a personal digital assistant (PDA), etc., and a specific type of the electronic device will not be limited in the present disclosure.

Based on the foregoing descriptions, the music creating method provided by the present disclosure will be illustrated in detail by taking the electronic device as an example, in conjunction with the accompanying drawings and application scenarios in the embodiments of the present disclosure.

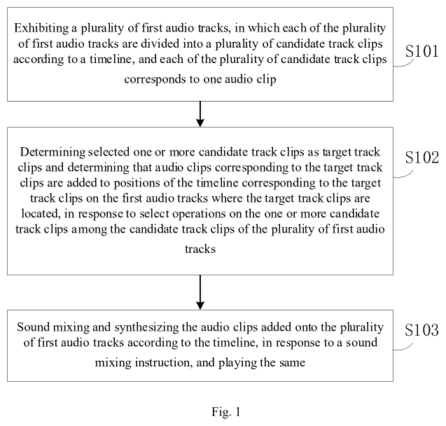

Referring to FIG. 1, FIG. 1 is a schematic flow chart of a music creating method provided by an embodiment of the present disclosure. As shown in FIG. 1, the music creating method provided by the present disclosure may include:
S101: exhibiting a plurality of first audio tracks, in which each of the plurality of first audio tracks are divided into a plurality of candidate track clips according to a timeline, and each of the plurality of candidate track clips corresponds to one audio clip.

A music creation tool may be installed in the electronic device, and the music creation tool may provide a variety of types of audio tracks. The electronic device may add an audio clip for sound mixing and synthesizing on an audio track in response to an operation of a user. Each type may correspond to one or more audio tracks, the numbers of audio tracks of different types may be the same or different, and the numbers of audio tracks corresponding to some types may support user adjustment in a creation process.

In which, the variety of types of audio tracks provided by the music creation tools may include but are not limited to: a first audio track corresponding to instruments, a second audio track corresponding to music remix capabilities, and so on. In which, each of the types may include one or more audio tracks, and the types of the audio tracks provided by the music creation tool and the numbers of the audio tracks included in respective types will not be limited in the present disclosure.

The music creation tool may provide the first audio track corresponding to the instruments. The first audio track may be divided into a plurality of candidate track clips according to the timeline, and position intervals on the timeline that are covered by the candidate track clips on the plurality of first audio tracks may be the same, or, it may also be understood that lengths of the candidate track clips on the plurality of first audio tracks are the same. The plurality of first audio tracks may be divided according to a set music rhythm, and each of the candidate track clips corresponds to one beat. In which the slower the set music rhythm, the longer the interval on the timeline that is covered by a corresponding candidate track clip; while the faster the set music rhythm, the shorter the interval on the timeline that is covered by a corresponding candidate track clip. In which the music rhythm supports user adjustment.

In which the plurality of candidate track clips belonging to a same first audio track correspond to a same audio clip, that is, correspond to an audio clip of a same instrument; the candidate track clips belonging to different first audio tracks correspond to different audio clips, that is, correspond to audio clips of different instruments. It should be noted that a time range corresponding to a candidate track clip on the timeline (hereinafter referred to as a duration corresponding to the candidate track clip) and a duration of an audio clip corresponding to the candidate track clip may be consistent or inconsistent with each other.

The audio clips respectively corresponding to the candidate track clips on the each of the first audio tracks may be played with corresponding instruments, recorded, processed, and then stored in a storage space of the electronic device in advance. Based on a select operation by the user on a candidate track clip, a corresponding audio clip may be read from the storage space of the electronic device and added to a position on the timeline that corresponds to the corresponding candidate track clip on the first audio track where the currently operated candidate track clip is located.

The music creation tool may exhibit the plurality of first audio tracks and the plurality of candidate track clips included in the each of the first audio tracks through the electronic device. The exhibition style is not be limited in the present disclosure. For example, in the user interface exhibited on the electronic device, each of the first audio tracks may correspond to one exhibition region; within the exhibition region corresponding to each of the first audio tracks, each of the candidate track clips respectively corresponds to one exhibition region; the exhibition regions respectively corresponding to the plurality of candidate track clips included in the first audio track may be sequentially arranged in a chronological order of positions of the plurality of candidate track clips on the timeline, for example, sequentially arranged from left to right, or sequentially arranged from top to bottom, and so on. Exhibition regions respectively corresponding to the plurality of candidate track clips belonging to the same first audio track do not overlap with each other, which facilitates the user to clearly distinguish between the plurality of candidate track clips and execute the select operation.

In some embodiments, the plurality of first audio tracks may be generated and set as manually triggered by the user one by one, and the user sets the audio clips corresponding to the respective candidate track clips on the respective first audio tracks by setting instruments corresponding to the first audio tracks.

In other embodiments, the music creation tool may automatically match an instrument combination according to the music style selected by the user, generate a plurality of first audio tracks respectively corresponding to the plurality of instruments included in the instrument combination, divide the respective first audio tracks into a plurality of candidate tracks according to the timeline; and respectively determine the audio clips corresponding to the plurality of candidate track clips on each of the first audio tracks based on the instruments corresponding to the respective first audio tracks.

In which a variety of music styles may be preset in the music creation tool, each of the music styles corresponds to an instrument combination, during music creation, music style information input by the user may be obtained, and correspondence relationships between the preset music styles and the instrument combinations may be queried to determine the instrument combination corresponding to the music style specified by music style information input by the user, and respectively establish corresponding first audio tracks for respective instruments in the instrument combination. Therefore, in the present embodiment, the number of the first audio tracks may be one or more, and the number thereof is related to the music style (the number of the instruments included in the instrument combination corresponding to the music style).

It should be noted that each of the instruments may correspond to a plurality of audio clips, and different audio clips may have different durations, tones and volumes, etc. Based on different strategies, an appropriate audio clip may be automatically selected from the plurality of audio clips corresponding to the instrument in response to a select operation by the user and added to a position of a corresponding candidate track clip on the timeline. The strategy mentioned here may be, but is not limited to, selecting a duration as close as possible to a duration of the candidate track clip, based on duration selection of the candidate track clip, and so on.

For example, if the user wants to create Chinese style music, inputting music style information to the music creation tool to indicate that the music style to be created is Chinese style, then the music creation tool may match three traditional Chinese instruments, namely, the erhu, the guzheng and the pipa for the user, and establish first audio tracks respectively corresponding to the erhu, the guzheng and the pipa, the user may add a rhythm audio clip corresponding to the erhu on the first audio track corresponding to the erhu, add a rhythm audio clip corresponding to the guzheng on the first audio track corresponding to the guzheng, and add a rhythm audio clip corresponding to the pipa on the first audio track corresponding to the pipa.

Through the music styles, the instrument matching problem may be solved for the user with just one click, which reduces users' requirements for understanding the instruments and the music styles.

It should be noted that the first audio track may be understood as an audio track that supports pre-edition; on the timeline, playback may be triggered at desired time, and an audio clip at each rhythm point (i.e., a target track clip) may be added, deleted or modified. And the first audio track may be added or deleted arbitrarily.

Of course, the plurality of first audio tracks may also be determined in other modes, which are not limited to the implementation of the above-described examples.
S102: determining selected one or more candidate track clips as target track clips and determining that audio clips corresponding to the target track clips are added to positions of the timeline corresponding to the target track clips on the first audio tracks where the target track clips are located, in response to select operations on the one or more candidate track clips among the candidate track clips of the plurality of first audio tracks.

The select operations on the candidate track clips may include but are not limited to operations such as clicking, double clicking, long pressing and sliding, etc. In addition, the select operations on the candidate track clips on different first audio tracks may be operations of the same type or different types, which will not be limited in the present disclosure.

In which the selected candidate track clips are the target track clips. The audio clips corresponding to the selected candidate track clips are the audio clips added onto the first audio tracks, which may participate in sound mixing and synthesizing. Audio clips corresponding to candidate track clips having not been selected may be understood as audio clips that are not added onto the first audio tracks and cannot participate in sound mixing and synthesizing.

In response to the select operation on the candidate track clips, the selected candidate track clips and the unselected candidate track clips may adopt different display styles, and the selected candidate track clips on different first audio tracks may adopt different display styles, to facilitates distinction by the user, for example, exhibition regions corresponding to the candidate track clips on the user interface are padded with different colors.

Combining with step S101, a duration corresponding to a target track clip may be consistent or inconsistent with a duration of a corresponding audio clip. If the duration corresponding to the target track clip is consistent with the duration of the corresponding audio clip, then the audio clip is added to a position interval of the target track clip on the timeline, and a start moment of the audio clip is consistent with a start moment of the target track clip on the timeline, for example, if the user selects a first candidate track clip on a certain first audio track, then audio clip 1 is added to a position interval of a first track clip on the timeline, that is, the audio clip 1 occupies one track clip. If the duration corresponding to the target track clip is inconsistent with the duration of the corresponding audio clip, the audio clip is added to position intervals of the selected candidate track clip and adjacent one or more candidate track clips on the timeline, and a start moment of the audio clip is consistent with a start moment of the selected candidate track clip on the timeline, for example, if the user selects a first track clip on a certain first audio track, and a duration of audio clip 2 is 1.5 times the duration of the selected track clip, then the audio clip 2 is added to position intervals of the first track clip and a second track clip on the timeline, that is, the audio clip occupies two track clips. which may also be understood as that the target track clip includes a plurality of candidate track clips.
S103: sound mixing and synthesizing the audio clips added onto the plurality of first audio tracks according to the timeline, in response to a sound mixing instruction, and playing the same.

The music creation tool may acquire the sound mixing instruction input by the user, sound mix and synthesize the audio clips added onto the plurality of first audio tracks according to the timeline in response to the sound mixing instruction, and play the same. In which, the sound mixing instruction may be but not limited to being triggered by the user through operating one or more buttons on the interactive interface provided by the music creation tool.

In some embodiments, the music creation tool may provide a start sound mixing control and an end sound mixing control, when the user operates the start sound mixing control, the music creation tool may automatically start sound mixing and synthesizing the audio clips on the respective first audio tracks, and stop sound mixing and synthesizing until the user operates the end sound mixing control.

In other embodiments, the music creation tool may provide a start sound mixing control, an end sound mixing control, and a playback button that controls synchronous playback and pause of the plurality of first audio tracks, when the user sequentially operates the start sound mixing control and the playback button. the music creation tool starts sound mixing and synthesizing the audio clips on the respective first audio tracks and stop sound mixing and synthesizing until the user operates the end sound mixing control. It should be noted that due to a chronological order between the start sound mixing control and the playback button operated by the user, there is no mixed audio input data during the time period; and in an exported audio file, an audio clip corresponding to the time period may be understood as a mute clip.

In which start positions of the respective first audio tracks are aligned on the timeline, and in response to the sound mixing instruction. the audio clips on the respective first audio tracks may be mixed and synthesized from a start moment position of the timeline, and the synthesized audio data may be played. During synthesizing, with respect to a moment position of synthesizing, audio data at corresponding moment positions of the audio clips whose position intervals cover the moment positions on the respective first audio tracks is mixed.

It should be understood that sound mixing may also be triggered in other ways, which is not limited to the implementations shown in the above-described examples.

During sound mixing and synthesizing, mixed audio data may be obtained through sound mixing and synthesizing based on the relationships between the respective audio clips on the timeline, and then the mixed audio data is input to a sound card for conversion and playback; or the audio clips on the respective first audio tracks may also be input into the sound card through different channels for playback, and then sound output from the sound card is recorded, so as to obtain the mixed audio data.

In the method provided by the present embodiment, the first audio track is divided into the plurality of candidate track clips according to the timeline, each of the candidate track clips corresponds to one beat, in addition, the correspondence relationships between the plurality of candidate track clips on the first audio tracks and the audio clips are established in advance, so that the user may add audio clips to corresponding beats by execute a simple select operation on one or more candidate track clips among the plurality of candidate track clips, which facilitates the user to understand and create music; afterwards, in response to a playback instruction for the plurality of first audio tracks, the audio clips added onto the plurality of first audio tracks are subjected to sound mixing and synthesizing according to the timeline for playback, allowing the user to preview the synthesized audio he/she has created. Besides, the music creation tool that utilizes the abstract music data model and the digital creation chain is provided to reduce barriers for the user to create and edit music, and may create a complete composition of music with merely a mobile device, which breaks the existing hardware device limitations for music creation.

On the basis of the embodiment shown in FIG. 1, the music creation tool may also export the mixed audio data obtained by sound mixing and synthesizing the audio clips on the plurality of first audio track according to the timeline in response to an export instruction, and store the same as an audio file in a specified format.

In which a duration of the audio file may be determined according to the length of the first audio track, or may also be a preset duration, or may also be determined according to a sound mixing start moment to a sound mixing end moment as controlled by the user.

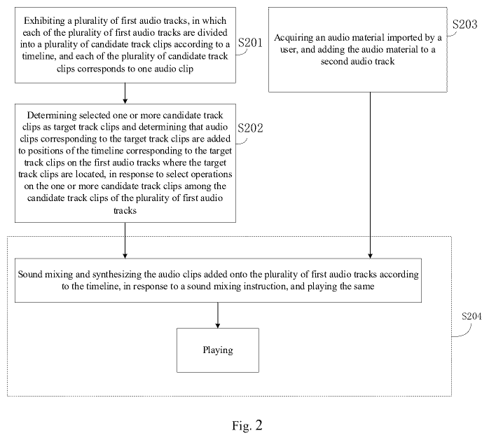

Referring to FIG. 2, FIG. 2 is a flow chart of a music creating method provided by another embodiment of the present disclosure. As shown in FIG. 2, the method according to the present embodiment may include:
S201: exhibiting a plurality of first audio tracks, in which each of the plurality of first audio tracks are divided into a plurality of candidate track clips according to a timeline, and each of the plurality of candidate track clips corresponds to one audio clip.
S202: determining selected one or more candidate track clips as target track clips and determining that audio clips corresponding to the target track clips are added to positions of the timeline corresponding to the target track clips on the first audio tracks where the target track clips are located, in response to select operations on the one or more candidate track clips among the candidate track clips of the plurality of first audio tracks.

The step S201 and step S202 may refer to the detailed descriptions of step S101 and step 102 in the embodiment shown in FIG. 1. For simplicity, no details will be repeated here.
S203: acquiring an audio material imported by a user, and adding the audio material to a second audio track.

The audio material may be an existing song imported by the user, which may be subjected to processing such as crop, tempo change, tone change, voice change, etc. as a portion of a mixed audio combination, or may also be pure existing voice, for example, freestyle rap and song without music. The second audio track facilitates the user to make secondary creation of an existing work.

In some embodiments, the music creation tool may exhibit an entrance that imports the audio material for sound mixing to the user through an electronic device, through the entrance, the user may enter an audio material selection page for selection, in which the audio material selection page may exhibit audio materials that are available for the user to select from in a thumbnail aggregation manner. And the music creation tool may provide the user with controls or function panels corresponding to user audio processing through the electronic device, which facilitates the user to perform audio processing on the selected audio material. Of course, the original audio material imported by the user and the audio material added onto the plurality of first audio tracks may also be directly mixed and synthesized without audio processing.

It should be noted that the second audio track may also be understood as an audio track that supports pre-edition, on the timeline, playback may be triggered at desired time, and the audio material on the second audio track may be deleted, replaced, and subjected to audio processing at any time.

In which the operation on the first audio track and the operation on the second audio track may be performed in no particular chronological order and may be executed repeatedly.
S204: sound mixing and synthesizing the audio clips added onto the plurality of first audio tracks and the audio material added onto the second audio track according to the timeline, in response to a sound mixing instruction, and playing the same.

The music creation tool may acquire the sound mixing instruction input by the user, sound mix and synthesize the audio clips added onto the plurality of first audio tracks and the audio material added onto the second audio track in response to the sound mixing instruction, and play the same. In which the sound mixing instruction may be, but not limited to, being triggered by the user operating one or more buttons on the interactive interface provided by the music creation tool.

In some embodiments, the music creation tool may provide a start sound mixing control and an end sound mixing control, when the user operates the start sound mixing control, the music creation tool may automatically start sound mixing and synthesizing the audio clips on the respective first audio tracks and the audio material on the second audio track and stop sound mixing and synthesizing until the user operates the end sound mixing control. By such means, it may be understood that the first audio track and the second audio track are aligned on the timeline, and the audio material on the second audio track starts from the start moment position of the timeline.

In other embodiments, the music creation tool may provide a start sound mixing control, an end sound mixing control, playback button 1 that controls synchronous playback and pause of the plurality of first audio tracks, playback button 2 that controls playback and pause of the second audio track; when the user sequentially operates the start sound mixing control, the playback button 1 and the playback button 2. in which a chronological order of operations on the playback button 1 and the playback button 2 is not limited, the music creation tool sound mixes and synthesizes the audio clips on the corresponding audio tracks according to an operation order of the user, and stops sound mixing and synthesizing until the user operates the end sound mixing control. It should be noted that, due to there is a chronological order when the user operates the start sound mixing control, the playback button 1. and the playback button 2. there is no mixed audio input data during the time period from operation on the start sound mixing control by the user to operation on the first playback button; and in an exported audio file, an audio corresponding to the time period may be understood as a mute clip. There is only an audio track corresponding to the first playback button that participates in sound mixing during the time period from operation on the start mixing control by the user to operation on the first playback button by the user to operation of the second playback button, so in an exported audio file, an audio corresponding to the time period may be a mixed audio clip on the audio track corresponding to the first playback button.

During sound mixing and synthesizing, mixed audio data may be obtained by sound mixing and synthesizing based on the relationships between the audio clips on the respective first audio tracks and the audio material on the second audio track on the timeline, and then the mixed audio data is input to a sound card for conversion and playback; or the audio clips on the respective first audio tracks and the audio material on the second audio track may also be input into the sound card through different channels for playback, and then sound output from the sound card is recorded, so as to obtain the mixed audio data.

On the basis of the embodiment shown in FIG. 2, the music creation tool may also export the mixed audio data obtained by sound mixing and synthesizing the audio clips on the plurality of first audio track and the audio material on the second audio track according to the timeline in response to an export instruction, and store the same as an audio file in a specified format.

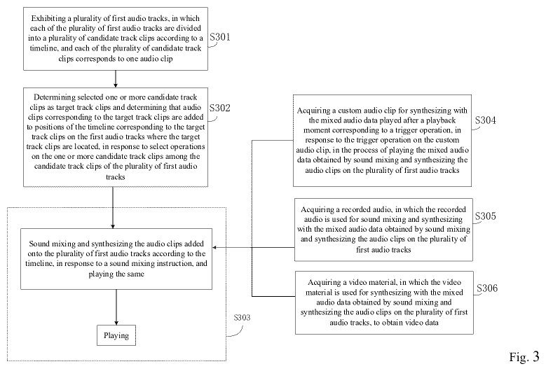

FIG. 3 is a schematic flow chart of a music creating method provided by another embodiment of the present disclosure. Referring to FIG. 3, the method according to the present embodiment includes:
S301: exhibiting a plurality of first audio tracks, in which each of the plurality of first audio tracks are divided into a plurality of candidate track clips according to a timeline, and each of the plurality of candidate track clips corresponds to one audio clip.
S302: determining selected one or more candidate track clips as target track clips and determining that audio clips corresponding to the target track clips are added to positions of the timeline corresponding to the target track clips on the first audio tracks where the target track clips are located, in response to select operations on the one or more candidate track clips among the candidate track clips of the plurality of first audio tracks.
S303: sound mixing and synthesizing the audio clips added onto the plurality of first audio tracks according to the timeline, in response to a sound mixing instruction, and playing the same.
S304: acquiring a custom audio clip for synthesizing with the mixed audio data played after a playback moment corresponding to a trigger operation, in response to the trigger operation on the custom audio clip. in the process of playing the mixed audio data obtained by sound mixing and synthesizing the audio clips on the plurality of first audio tracks.

In the process of playing the mixed audio data obtained by sound mixing and synthesizing the audio clips on the plurality of first audio tracks. the user may synchronously add a custom audio clip to add a free sound effect. In which the addition of the free sound effect (i.e., the custom audio clip) is not limited by minimum unit time, that is, it is not limited by the candidate track clip included on the first audio track, and may be triggered in real time by the user at any time node. Moreover, the user may add different custom audio clips at different playback moments.

In which the custom audio clip may include but is not limited to voices, electronic sounds, special effect sounds, etc. of some private brands of manufacturers and personal identifiers. The music creation tool may exhibit icons corresponding to different custom audio clips to the user through the electronic device; the user may add a custom audio clip by operating an icon, and the operation includes but is not limited to clicking, double clicking. long pressing, and so on.

In conjunction with the embodiment shown in FIG. 2, if the audio material is also added onto the second audio track, then in the process of playing the mixed audio data obtained by sound mixing and synthesizing the audio clips on the plurality of first audio tracks and the audio material on the second audio track, if the user triggers to add a custom audio clip, then the custom audio clip may be mixed with the mixed audio data after the playback moment corresponding to the trigger operation, and the mixed audio data is played. Here the mixed audio data is obtained by sound mixing and synthesizing the audio clips on the plurality of first audio tracks and the audio material on the second audio track.

Real-time improvisation, for example, an electronic sound, a voice special effect, etc. is provided, or may also be directly added conveniently during sound mixing, which may improve the user's interest in creation and may also ensure the created audio to meet expectations of the user. In addition, the music creation tool may also export the audio data obtained by sound mixing and synthesizing the audio clips on the plurality of first audio tracks and the custom audio clip according to the timeline in response to an export instruction, and store the same as an audio file in a specified format.

Optionally, on the basis of the embodiment shown in FIG. 3, the method further includes:
S305: acquiring a recorded audio, in which the recorded audio is used for sound mixing and synthesizing with the mixed audio data obtained by sound mixing and synthesizing the audio clips on the plurality of first audio tracks.

In some embodiments, when playing the mixed audio data obtained by sound mixing and synthesizing the audio clips on the plurality of first audio tracks, a voice pickup module (e.g., a microphone) may be turned on to synchronously record to acquire a recorded audio in real time, so as to add a voice effect to the synthesized music, or, it may also be understood that the mixed audio data synthesized from the plurality of first audio tracks is background music presentation of the recorded audio.

In addition, in the sound mixing process, the user may turn on or turn off audio recording at any time.

Through step S305, the chain between music creation and original sound input may be established to meet the user's creative needs. In addition, the music creation tool may also export the audio data obtained by sound mixing and synthesizing the audio clips on the plurality of first audio tracks and the recorded audio according to the timeline, in response to an export instruction, and store the same as an audio file in a specified format.

Optionally, on the basis of the embodiment shown in FIG. 3, the method further includes:
S306: acquiring a video material, in which the video material is used for synthesizing with the mixed audio data obtained by sound mixing and synthesizing the audio clips on the plurality of first audio tracks, to obtain video data.

In which the video material may be an existing video that may be imported by the user from the electronic device, or may also be a video recorded in real time by activating a camera of the electronic device during a playback process, or may also be a combination of both, which will not be limited in the present disclosure. If the video material not only includes a video imported by the user, but also includes a video recorded in real time by activating the camera, then in the video recorded in real time, the existing video imported by the user from the electronic device may be played as a recorded picture in picture, or may also completely replace the recorded video, that is, the picture in picture occupies the entire video picture. In addition, if the video material includes the existing video imported by the user, then it may be imported before starting the sound mixing process, that is, before the user inputs the sound mixing instruction.

In which when synthesizing the video material with the mixed audio data, the mixed audio data may serve as a background sound to blend with the video material, which may facilitate the user to create a music video (MV), to meet creative needs of the user. On the basis of the embodiment shown in FIG. 3, before synthesizing, the video material may also be subjected to image processing, and a mode of the image processing includes but is not limited to: filters, special effects, image enhancement, rotation, and so on. If the video material is recorded in real time, each frame of video image captured by the camera may be processed and synchronously synthesized with the audio track in the recording process; if the video material is imported by the user, the video frame image may be subjected to image processing frame by frame and synchronously synthesized with the audio track in the synthesis process.

In the method according to the embodiment, the video recording function is further provided through the music creation tool, which fully connects the complete chain from music creation, original sound input to audio recording, and at the same time, adds functions of video recording, special effects rendering, and MV saving, thereby providing a one-stop solution for video/audio creation.

In addition, the music creation tool may further export the video data obtained by synthesizing the audio clips on the plurality of first audio tracks and the video material according to the timeline, in response to the export instruction. and store the same as a video file in a specified format.

On the basis of the embodiment shown in FIG. 3. in the process of playing the mixed audio data obtained by sound mixing and synthesizing the audio clips on the plurality of first audio tracks, the above-described step S304 to step S306 may be executed in parallel.

In conjunction with the embodiments shown in FIG. 1 to FIG. 3, music creation may be performed through the functions provided by the music creation tool, which may implement low-barrier music creation, enrich original music resources, improve creative enjoyment, enhance user's interest in creation, stimulate creative potential of the user, and enrich music creation forms. In addition, the music creation tool may be deployed on a mobile device. and music creator capabilities may be implemented on the mobile device, so that music creation is not limited, and the user may express inspiration anytime. anywhere. In addition, the above-described various capabilities possessed by the music creation tool may implement professional creation and simplify the music creation process, which stimulates public interest and makes it possible to generalize music creation.

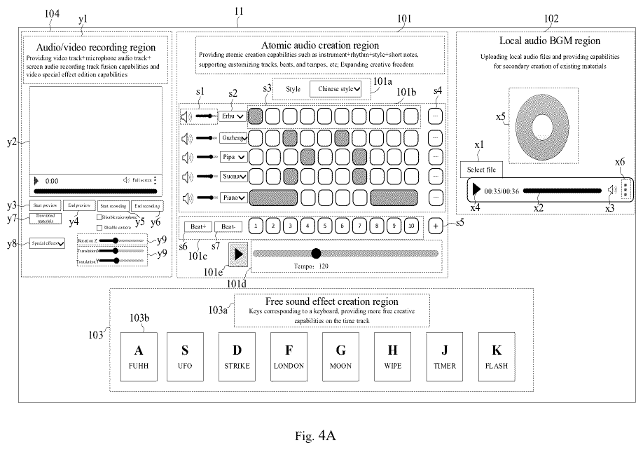

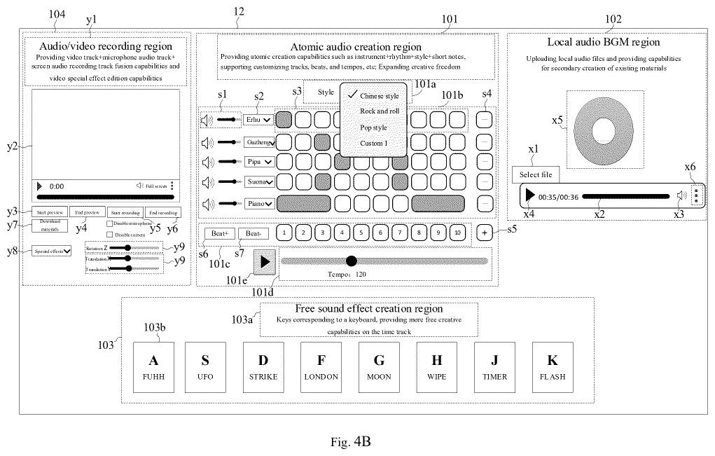

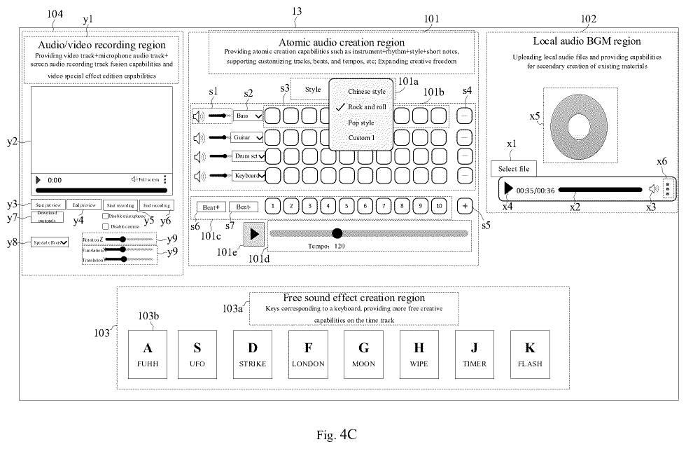

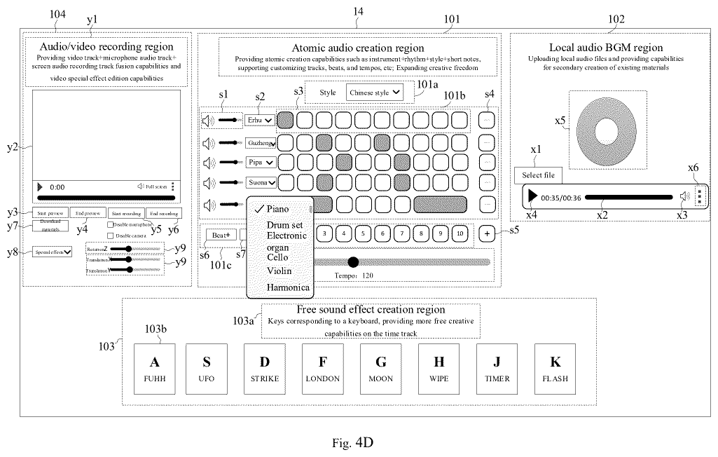

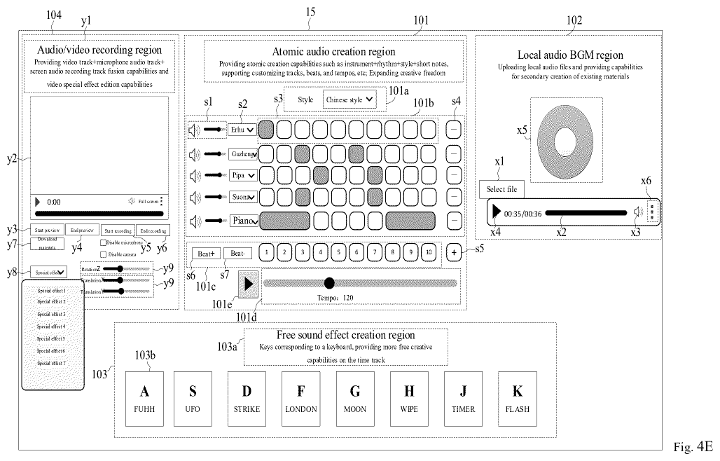

Based on the foregoing descriptions. the music creating method provided by the present disclosure will be illustrated in detail in conjunction with the schematic diagrams of interactive interfaces shown in FIG. 4A to FIG. 4E. For convenience of illustration, in FIG. 4A to FIG. 4E, it is illustrated by taking that the electronic device is a mobile phone, a music creation tool is installed in the mobile phone, and music creation is performed through application 1 as an example.

Referring to FIG. 4A to FIG. 4E. FIG. 4A to FIG. 4E are schematic diagrams of human-computer interactive interfaces provided by the embodiment of the present disclosure.

The music creation tool is started. a music style is selected, audio clips of corresponding instruments are added onto first audio tracks and an audio material is added onto a second audio track, the music creation tool may display a user interface 11 as shown in FIG. 4A on the mobile phone, in which the user interface 11 includes: a region 101, a region 102, a region 103 and a region 104.

In which the region 101 may be understood as an atomic audio creation region. in the region 101, the user may select a music style so that an instrument combination and corresponding first audio tracks are automatically determined and displayed based on the music style, and may also add or delete the first audio tracks, change a length of the timeline, increase or decrease beats, adjust a tempo, and so on.

Exemplarily, referring to FIG. 4A. the region 101 includes: a tab 101a and a region 101b; the tab 101a is used for triggering to display of a style list, while the region 101b is used for displaying the first audio tracks corresponding to the currently selected style, as well as components or information related to the first audio tracks.

Exemplarily, the music creation tool may display a user interface 12 as shown in FIG. 4B in response to a trigger operation on the tab 101a; the user interface 12 includes a music style list; the music style list includes a variety of music style options for the user to select; the user may view more music style options by sliding up or down or by other means to switch music styles; and one or more first audio tracks of the instrument combination corresponding to the selected music style option are displayed in the region 101b. In some cases, when the music creation tool is started, the plurality of first audio tracks corresponding to the instrument combination corresponding to the specified style may be displayed by default, the candidate track clips on the respective first audio tracks are all in an unselected state, and the timeline length of the first audio track may also be displayed according to a default length, for example, ten time units are displayed by default. In addition, when entering the music style list, the currently selected music style may be displayed as a selected state, while others are in an unselected state.

On the basis of the embodiment shown in FIG. 4B, assuming that in response to a trigger operation (e.g., clicking) by the user on a rock option in the music style list, the music creation tool may exemplarily display a user interface 13 as shown in FIG. 4C on the mobile phone, the region 101b displays the first audio tracks respectively corresponding to the instruments corresponding to a rock style, namely, a bass, a guitar, a drum set, and a keyboard. Afterwards, the user may exit the music style list by clicking anywhere outside of the music style list.

Referring to FIG. 4B, the music style list may further include a custom style option, for example, a “custom 1” option as shown in FIG. 4B. In some embodiments, the custom style option may include an instrument combination previously defined by the user; when the user selects the custom style option, a plurality of first audio tracks corresponding to the corresponding instrument combination may be displayed; in other embodiments. the region 101b may display no first audio track, but instead, generate a custom style option as the user triggers addition of a custom style, adds a first audio track to the generated custom style option by adding a new audio track, sets an associated instrument type, and saves instrument combination information of the custom style option to the music style list, which facilitates the user to use next time. Different custom style options may be distinguished through music style names, and the music style name may be edited by the user.

With further reference to FIG. 4A. the region 101b may include a display region corresponding to each of the first audio tracks, and the display region corresponding to any one of the first audio tracks may include a tab s1 for setting a volume of an audio clip, a tab s2 for modifying an instrument type, a track s3, and a tab s4 for deleting.

In which the track s3 is divided into a plurality of track clips according to time, as shown in FIG. 4A, which displays a plurality of square regions arranged from left to right; each of the square regions represents one track clip, the user may select a track clip by operating the corresponding square region and add a corresponding audio clip to a corresponding position of the track on the timeline on the first audio track; a display style of the selected track clip may be different from a display style of other unselected track clips, for example, as shown in FIG. 4A. the square regions corresponding to the selected track clips are gray, while the square regions corresponding to the unselected track clips are white. In addition, the selected track clips on different first audio tracks may have different display styles, for example, may have different colors; and the unselected track clips on different first audio tracks may adopt the same display style, for example, all in white.

Exemplarily, the gray regions on the respective first audio tracks on the user interface 11 as shown in FIG. 4A represent the selected track clips. Since audio clips corresponding to different instruments may have different time lengths, some may need to occupy one or more track clips, when an audio clip needs to occupy a plurality of track clips, the square regions of the plurality of track clips may be merged in response to a select operation by the user, for example, on a first audio track corresponding to piano in the last row, a 1-st time unit to a 3-rd time unit may be merged, and an 8-th time unit to a 10-th time unit may be merged, and such an audio clip corresponding to piano corresponds to a time range corresponding to three track clips on the timeline.

In addition, the user may operate (e.g., continuously click) square regions corresponding to the same track clip multiple times to adjust tones of the audio clips, which, on the user interface, may be distinguished by, but not limited to, color brightness, for example, the brighter the color, the higher the tone, and the darker the color, the lower the tone.

In addition, the region 101 may further include a tab s5 for newly adding an audio track. By operating the tab s5, a first audio track may be added, in some embodiments, the newly added first audio track may be added in the last row according to an arrangement order of the audio tracks, afterwards, an instrument corresponding to the track may be set by operating the tab s2 for modifying an instrument type corresponding to the newly added first audio track.

In which with respect to the tab s2 corresponding to any one of the first audio tracks, the music creation tool may display a user interface 14 on the mobile phone as shown in FIG. 4D in response to a trigger operation (e.g., clicking) on the tab s2 by the user. and the user interface 14 displays an instrument list. so that the user may select a desired instrument from the instrument list. After selection, the user may exit the instrument list by triggering any position outside the list region on the display screen. In which the respective instruments in the instrument list may be sequentially displayed in a set order, or may also be displayed in a categorized manner according to an instrument category. and a name of each category is displayed in the instrument list. which will not be limited in the present disclosure, and FIG. 4D shows the former case.

In addition, the region 101 further includes a region 101c, the region 101c is used for displaying the timeline corresponding to the atomic creation region, time units included in the current timeline in the region 101c are arranged in an order, the user may add a time unit or delete a time unit by operating a tab s6 for increasing a beat and a tab s7 for decreasing a beat, so as to change the length of the timeline, if the user wants to add or delete a plurality of time units, he/she may successively operate (e.g., successively click) the tab s6 and the tab s7 multiple times.

It should be noted that modification of the timeline in the region 101c by the user will cause changes in length of the respective first audio tracks in the region 101b on the user interface 11, and the corresponding number of candidate track clips will be synchronously added or deleted on the first audio tracks in the region 101c.

In addition, the region 101 further includes a region 101d, the region 101d is used for exhibiting a tempo adjustment axis, which may also be understood as a music rhythm fast/slow adjustment axis or a music beat fast/slow adjustment axis, the user may adjust the music rhythm by dragging an adjustment button on the tempo adjustment axis, the region 101d may display a current tempo value, and the larger the tempo value, the faster the music rhythm is. For example, as shown in FIG. 4A, the current tempo is: 120, the tempo may be decreased by dragging the adjustment button to the left, and the tempo may be increased by dragging the adjustment button to the right, and in the adjustment process, the tempo value displayed in the region 101d changes synchronously with adjustment.

It should be noted that after the tempo is adjusted, a length of each of the time units on the timeline will change, and intervals covered by the candidate track clips on each of the first audio tracks on the timeline will also change, the higher the tempo value, the shorter the duration of the time unit, and the smaller the intervals covered by the candidate track clips on the timeline: the lower the tempo value, the longer the duration of the time unit, and the larger the intervals covered by the candidate track clips on the timeline. After the tempo is adjusted, a display style of identifiers of the time units displayed in the region 101b and the region 101c on the user interface may remain unchanged (e.g., sizes of the square regions representing the time units and the candidate track clips remain unchanged), or may also change (e.g., sizes of the square regions representing the time units and the candidate track clips become longer or shorter as the rhythm slows down).

In addition, since the overall music rhythm is adjusted, the tempo of the audio clips corresponding to the selected candidate track clips also needs to be adjusted so that the tempo of the rhythm audio clips is consistent with the adjusted music rhythm, thereby adapting to the duration of the adjusted time units.

In addition, the region 101 further includes: a playback button 101e, the playback button 101e may be operated to control the electronic device to play the audio clips on the plurality of first audio tracks in the region 101 for the user to preview a sound mixing effect. During preview of playback, the audio clips may be played according to the timeline, and on the user interface, the audio clips may be arranged in an order from left to right in the region 101b and played. Moreover, the square regions corresponding to a column of track clips corresponding to a playback position may be displayed in a highlighted manner with the playback position. for example. the square regions corresponding to the column of track clips may change in position and the size.

The region 102 may be understood as a local audio BGM creation region. and the user may operate the region 102 to upload a local audio file for secondary creation. The audio file uploaded by operating the region 102 is added onto the second audio track. By operating the region 102, tempo change, voice change, crop, tone change, volume setting, etc. may also be performed on the uploaded audio file. Exemplarily, as shown in FIG. 4A, the region 102 includes: a tab x1, a time axis x2, a volume setting button x3, a playback button x4, and a region x5 for exhibiting special effects. In which the tab x1 is used for entering an audio file selection page, and through the audio file selection page. the user may select an audio material to be imported for secondary creation and add the same onto the second audio track. The time axis x2 may exhibit a total duration and playback progress of the audio material added by the user. The volume setting button x3 may increase or decrease a volume of the audio material on the second audio track during synthesizing. In addition, the region 102 may further include: a tab x6 for entering an audio processing function panel, the audio processing function panel may provide buttons or components corresponding to one or more audio processing functions such as crop, tempo change, voice change, tone change, etc., and by triggering corresponding buttons or components, the audio material on the second audio track may be subjected to processing such as crop, tempo change, voice change, tone change and so on. The audio processing function panel may further provide a download function, to download the audio material obtained through audio processing. In some embodiments, tabs corresponding to some audio processing functions may also be set in the region 102, for example, the buttons or the components respectively corresponding to crop, tempo change, voice change, tone change are set in the region 102 (e.g., below black frame in the regions where the tab x2, the tab x3. the tab x4 and the tab x6 are located), in order to facilitate the user to use, the tab x6 may be omitted and a download button may be set in the region 102 to facilitate the user to download the audio material obtained through audio processing.

Pre-edition of the first audio track and the second audio track may be implemented through the region 101 and the region 102.

The region 103 is a free sound effect creation region, keys on a keyboard provided in the region 103 may be operated to add free sound effects corresponding to the keys at any time point on the third audio track. In addition, the free sound effects corresponding to the respective keys on the keyboard support user customization, the user may bind custom audio clips of his/her favorite sound effects to the keys according to needs, and use them during creation. Exemplarily, the region 103 includes a region 103a and a plurality of keys 103b, the region 103a is used for exhibiting a theme content of the region 103, for example, the region 103a displays a region name “free sound effect creation region” and detailed introduction of the region “keys corresponding the keyboard, providing more free creative capabilities on the time track”, in addition, the plurality of keys 130b may respectively correspond to music of different brands, for example, as shown in FIG. 4A, in an order from left to right, the plurality of keys 103b sequentially correspond to music of brands, namely, FUHH, UFO, STRIKE, LONDON, MOON, WIPE, TIMER, FLASH, ORDER, and sequentially correspond to the identifiers of A, S, D, F, G, H, J, K. The number of keys on the keyboard will not be limited in the present disclosure, the user may customize addition and deletion according to needs, and a display style of the keyboard will not be limited, in addition to the mode shown in FIG. 4A, other display styles may also be adopted, for example, the keys may be circular, the color can be colored, and the identification can also be in other fonts and sizes.

In which the audio clips on the first audio track may be played by triggering the playback button in the region 101, and the audio clips on the second audio track may be played by triggering the playback button in the region 102, in the playback process, free sound effects may be added to any timeline on the timeline by operating the keys on the keyboard in the region 103.

The region 104 is an audio/video creation region. the user may record an environmental audio/video in real time by operating buttons in the region 104, or may also import an existing video material from the electronic device by operating the buttons in the region 104. Moreover, the recorded video/imported video may be previewed through a preview window, in addition, the video material may also be processed through an image processing related button. Exemplarily, as shown in FIG. 4A, the region 104 includes a region y1, a preview window y2, a start preview tab y3, an end preview tab y4, a start recording tab y5, an end recording tab y6, a download material tab y7, a special effects tab y8, a rotation component y9, and a movement component y10.

In which the region y1 displays a theme and detailed introduction of the region 104 for the user, for example, displays a text content “audio/video creation region” and “providing video track+microphone track+sound mixing track collection fusion capabilities and video special effect edition”, and of course, may also display other content, which will not be limited in the present disclosure.

The preview window y2 may display a video picture recorded in real time, or may also be used for previewing playback of video data obtained by synthesizing the video material and other audio track after recording ends. A size and a display style of the preview window y2 will not be limited in the present disclosure.

The start preview tab y3 is used for triggering playback of the video data obtained by synthesizing the video material and other audio track in the preview window y2, similarly, the end preview tab y4 is used for triggering end of playback of the video obtained by synthesizing the video material and other audio track in the preview window y2.

The start recording tab y5 is used for triggering to record an audio material and/or a video material and triggering to start of mixed audio recording. In some embodiments, an option to enable a microphone to record an audio and an option to enable a camera to record a video may also be set, the user may select to enable the microphone separately or enable the camera separately for recording, or the user may also select both at the same time, so that such setting provides greater flexibility. Or, buttons for disabling the microphone and the camera may be respectively set, when disabled is not selected, both the microphone and the camera are enabled at the same time for mixed audio recording by default. If disabled, it can be set based on needs.

The end recording tab y6 is used for the user to trigger to stop recording an audio material and/or a video material and end mixed audio recording.

The user triggers the start recording tab y5 to input a sound mixing instruction, triggers to start of mixed audio recording and synchronous start of recording a video and an audio, clicks a tab 101e and the tab x4 to play the audio clip on the first audio track and the audio material imported by the user, and may also add a free sound effect in the process of playing the recorded mixed audio data. Afterwards, the user triggers the start recording tab y6 to stop mixed audio recording and stop recording the audio and the video. It jumps to the preview interface for preview of the final mixed audio data/video data.

The download material tab y7 is used for exporting the finally obtained mixed audio data/video data as an audio/video file of a specified format.

The special effect tab y8 is used for entering a special effect list. Exemplarily, the music creation tool may display a user interface 15 as shown in FIG. 4E, in response to a trigger operation by user 1 on the special effect tab y8. the user interface 15 displays the special effect list, the special effect list exhibits respective special effects with names of the special effects, the user may select to use the special effects, in which on the user interface 15, the user may view more special effects through, but not limited to, sliding a screen up and down or scrolling a mouse wheel. In which the user may select a special effect to be used before starting recording, or may also select to use the special effect in the recording process, if the user selects to use a special effect during the recording process, the special effect will be applied to the video image recorded after a record moment when triggering selection to use the special effect, and the previously recorded video image did not have the special effect. In addition, after the user selects a special effect, the music creation tool may apply the special effect to a video frame image displayed in a current preview window in response to an operation by the user, and display the video frame image added with the special effect in the preview window for the user to preview the effect.

The rotation component y9 is used for rotating a video frame image of a video material, the rotation may be clockwise or counterclockwise, and a rotation direction will not be limited. A rotation angle range is 0 degree to 360 degrees. In the video recording process, the rotation component y9 may be triggered in real time to rotate a video picture.

The movement component y10 is used for moving a video frame image, the movement component may include a component for moving a video frame image along an X-axis and a component for moving a video frame image along a Y-axis. Since the movement of the video frame image may cause a portion of image region to move out of the preview window and the preview window will have a portion of region uncovered by the video frame image, the portion of uncovered window region may display a preset background color, for example, black, gray and so on. In the video recording process, the movement component y10 may be triggered in real time to move the video picture horizontally or vertically.

In addition, the region 104 may further include: a playback control for controlling preview playback and pausing preview playback, a time axis, a volume button, a full screen button, and an access to a video-related function panel, etc., and the function panel may include a control corresponding to a download function, a component for setting picture in picture, and so on.

In the embodiments illustrated in conjunction with FIG. 4A to FIG. 4E, the present disclosure provides the music creation tool that utilizes the abstract music data model and the digital creation chain to reduce barriers for the user to create and edit music, and may create a complete composition of music with merely a mobile device. Moreover, the music creation tool adds selections of rhythm, style and timbre on the basis of providing the user with atomic creation capabilities so that the user may create according to his/her own preference, and at the same time, migrates hardware device capabilities to software, breaking free from the expensive and heavy hardware device while fully simulating immersive music experience brought by the former, so that the user may create anytime, anywhere. In addition, the music creation tool further provides remix capabilities, allowing for secondary creation on the basis of existing works, so as to meet music creation needs of the user. Besides, the music creation tool may automatically initialize corresponding instrument tracks according to a style selected by the user, so as to match the style, which further facilitates the user to get started, reduce creation barriers for the user, and provides the user with original creative capabilities to a greater extent. Moreover, the music creation tool establishes a complete music creation chain, connecting the entire process from 0 to 1 in the creation process, including various nodes such as music creation, voice input, real-time video, special effects rendering and work saving, etc., which greatly improves creative interests of the user, and makes it possible to generalize music creation.

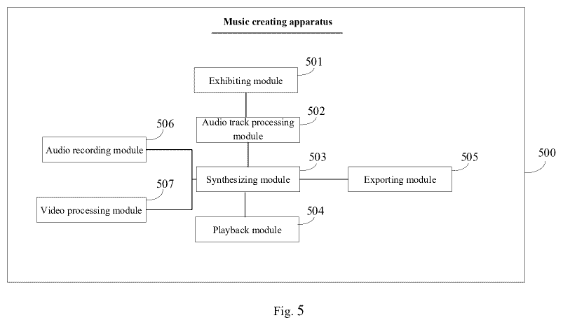

FIG. 5 is a structural schematic diagram of a music creating apparatus provided by an embodiment of the present disclosure. Referring to FIG. 5, the music creating apparatus 500 provided by the present embodiment includes:
an exhibiting module 501, configured to exhibit a plurality of first audio tracks, in which each of the plurality of first audio tracks are divided into a plurality of candidate track clips according to a timeline, and each of the plurality of candidate track clips corresponds to one audio clip.
an audio track processing module 502, configured to determine selected one or more candidate track clips as target track clips and determine that audio clips corresponding to the target track clips are added to positions of the timeline corresponding to the target track clips on the first audio tracks where the target track clips are located, in response to select operations on the one or more candidate track clips among the candidate track clips of the plurality of first audio tracks; in which the audio clips added onto a plurality of track clips belonging to a same one of the first audio tracks are the same; and the audio clips added onto the track clips of different first audio tracks are different.
a synthesizing module 503, configured to sound mix and synthesize the audio clips added onto the plurality of first audio tracks according to the timeline, in response to a sound mixing instruction.
a playback module 504, configured to play mixed audio data generated through sound mixing and synthesizing.

In some embodiments, the audio track processing module 502 is further configured to acquire a user-specified music style and determine an instrument combination that matches the music style based on the user-specified music style; generate first audio tracks respectively corresponding to respective instruments included in the instrument combination, and determine audio clips respectively corresponding to the plurality of candidate track clips on the first audio tracks respectively corresponding to the respective instruments; in which the audio clips respectively corresponding to the plurality of track clips on the first audio tracks are the audio clips of the instruments corresponding to the first audio tracks.

In some embodiments, the audio track processing module 502 is further configured to adjust a position range covered by the target track clips included in the plurality of first audio tracks on the timeline, and adjust a tempo of the corresponding audio clips based on an adjusted position range covered by the target track clips on the timeline, so that a duration of the audio clips matches the adjusted position range covered by the target track clips on the timeline.

In some embodiments, the audio track processing module 502 is further configured to generate and exhibit a newly added first audio track, in response to a trigger operation on a track addition control, and determine audio clips respectively corresponding to a plurality of candidate track clips of the newly added first audio track.

In some embodiments, the audio track processing module 502 is further configured to delete the first audio track corresponding to a track deletion control, in response to a trigger operation on the track deletion control.

In some embodiments, the apparatus further includes: an exporting module 505, configured to export the mixed audio data obtained by sound mixing and synthesizing the audio clips on the plurality of first audio tracks in response to an export instruction, and store the same as an audio file in a specified format.

In some embodiments, the audio track processing module 502 is further configured to add an audio material imported by the user onto the second audio track for sound mixing with the audio clips added onto the first audio track; in which a start moment position of a position interval covered by the audio material on the timeline is aligned with a start moment position of the timeline;

The synthesizing module 503 is configured to sound mix and synthesize the audio material on the second audio track and the audio clips on the plurality of first audio tracks according to the timeline to obtain mixed audio data in response to a sound mixing instruction; and the playback module 504 is configured to play the corresponding mixed audio data.

In some embodiments, the audio track processing module 502 is further configured to perform audio processing on the audio material on the second audio track, in which the audio processing includes one or more of crop, tempo change, tone change and voice change.

In some embodiments, the synthesizing module 503 is further configured to synthesize a custom audio clip with the mixed audio data played after a playback moment corresponding to a trigger operation, in response to the trigger operation on the custom audio clip, in the process of playing the mixed audio data obtained by sound mixing and synthesizing the audio clips on the plurality of first audio tracks; and the playback module 504 is configured to play the synthesized audio data.

In some embodiments, the apparatus 500 further includes: an audio recording module 506, configured to acquire a recorded audio. The synthesizing module 503 is further configured to further synthesize the recorded audio with the mixed audio data obtained by sound mixing and synthesizing the audio clips on the plurality of first audio tracks according to the timeline, and then play the synthesized audio data.

In some embodiments, the apparatus 500 further includes: a video processing module 507, configured to acquire a video material. The synthesizing module 503 is further configured to synthesize the video material with the mixed audio data obtained by sound mixing and synthesizing the audio clips on the plurality of first audio tracks according to the timeline, and play the obtained video data.

In some embodiments, the video processing module 507 is further configured to perform image processing on the video material to obtain a video material having a target image effect.

The apparatus according to the embodiment may be used for implementing the technical solution of any one of the foregoing method embodiments, implementation principles and technical effects thereof are similar thereto, the detailed descriptions of the foregoing method embodiments may be referred to, and for simplicity, no details will be repeated here.

Exemplarily, the present disclosure provides an electronic device, which includes: one or more processors; a memory; and one or more computer programs; in which the one or more computer programs are stored in the memory; the one or more processors, when executing the one or more computer programs, cause the electronic device to implement the music creating method according to any one of the foregoing embodiments.

Exemplarily, the present disclosure provides a chip system, applied to an electronic device including a memory and a sensor; in which the chip system includes a processor; and the processor executes the music creating method according to any one of the foregoing embodiments.

Exemplarily, the present disclosure provides a computer readable storage medium, having a computer program stored thereon, in which the computer program, when executed by a processor, causes an electronic device to implement the music creating method according to any one of the foregoing embodiments.

Exemplarily, the present disclosure provides a computer program product, in which the computer program product, when running on a computer, causes the computer to execute the music creating method according to any one of the foregoing embodiments.

It should be noted that, relational terms herein such as “first” and “second” are only used to distinguish one entity or operation from another entity or operation, and do not necessarily require or imply any actual relationship or order between these entities or operations. In addition, the terms “include”, “comprise”, or any other variants thereof are intended to cover a non-exclusive inclusion, so that a process, a method, a product or a device that includes a list of elements not only includes those elements but also includes other elements that are not expressly listed, or further includes elements inherent to such process, method, product or device. Without more constraints, the elements limited by the statement “including one . . .” does not exclude that there is another same or identical element in the process, method, product, or device that includes the element.

The above is only the specific implementation provided to enable those skilled in the art to understand and practice the present disclosure. Various modifications to these embodiments will be readily apparent to those skilled in the art, and the generic principles defined herein may be applied to other embodiments without departing from the spirit or scope of the present disclosure. Therefore, the present disclosure will not be limited to these embodiments described herein, but is to be accorded the widest scope consistent with the principles and novel features disclosed herein.

1. A music creating method, comprising:
exhibiting a plurality of first audio tracks, wherein each of the plurality of first audio tracks are divided into a plurality of candidate track clips according to a timeline, and each of the plurality of candidate track clips corresponds to one audio clip;
determining selected one or more candidate track clips as target track clips and determining that audio clips corresponding to the target track clips are added to positions of the timeline corresponding to the target track clips on the first audio tracks where the target track clips are located, in response to select operations on the one or more candidate track clips among the candidate track clips of the plurality of first audio tracks; wherein the audio clips added onto a plurality of target track clips belonging to a same one of the first audio tracks are the same; and the audio clips added onto the target track clips of different first audio tracks are different; and
sound mixing and synthesizing the audio clips added onto the plurality of first audio tracks according to the timeline, in response to a sound mixing instruction, and playing the same.

2. The method according to claim 1, wherein before the exhibiting a plurality of first audio tracks, the method further comprises:
acquiring a music style specified by a user and determining an instrument combination that matches the music style based on the music style specified by the user;
generating the first audio tracks respectively corresponding to respective instruments comprised in the instrument combination, and determining audio clips respectively corresponding to the plurality of candidate track clips on the first audio tracks respectively corresponding to the respective instruments; wherein the audio clips respectively corresponding to the plurality of track clips on the first audio tracks are the audio clips of the instruments corresponding to the first audio tracks.

3. The method according to claim 1, further comprising:
adjusting a position range covered by the target track clips comprised in the plurality of first audio tracks on the timeline, and adjusting a tempo of the corresponding audio clips based on an adjusted position range covered by the target track clips on the timeline, so that a duration of the audio clips matches the adjusted position range covered by the target track clips on the timeline.

4. The method according to claim 1, further comprising:
generating and exhibiting a newly added first audio track, in response to a trigger operation on a newly added track control, and determining audio clips respectively corresponding to a plurality of candidate track clips of the newly added first audio track.

5. The method according to claim 1, further comprising:
deleting a first audio track corresponding to a track deletion control, in response to a trigger operation on the track deletion control.

6. The method according to claim 1, further comprising:
exporting mixed audio data obtained by sound mixing and synthesizing the audio clips on the plurality of first audio tracks in response to an export instruction, and storing the same as an audio file in a specified format.

7. The method according to claim 1, further comprising:
adding an audio material imported by a user onto a second audio track for sound mixing with the audio clips added onto the first audio tracks; wherein a start moment position of a position interval covered by the audio material on the timeline is aligned with a start moment position of the timeline;
sound mixing and synthesizing the audio material on the second audio track and the audio clips on the plurality of first audio tracks according to the timeline in response to the sound mixing instruction, and playing the same.

8. The method according to claim 7, wherein after the adding an audio material imported by a user onto a second audio track, the method further comprises:
performing audio processing on the audio material on the second audio track, wherein the audio processing comprises one or more of crop, tempo change, tone change and voice change.

9. The method according to claim 1, further comprising:
synthesizing a custom audio clip with mixed audio data played after a playback moment corresponding to a trigger operation, in response to the trigger operation on the custom audio clip, in the process of playing the mixed audio data obtained by sound mixing and synthesizing the audio clips on the plurality of first audio tracks; and playing synthesized audio data.

10. The method according to claim 1, further comprising:
acquiring a recorded audio, further synthesizing the recorded audio with mixed audio data obtained by sound mixing and synthesizing the audio clips on the plurality of first audio tracks according to the timeline, and playing synthesized audio data.

11. The method according to claim 1, further comprising:
acquiring a video material, synthesizing the video material with mixed audio data obtained by sound mixing and synthesizing the audio clips on the plurality of first audio tracks according to the timeline, and playing obtained video data.

12. The method according to claim 11, further comprising:
performing image processing on the video material to obtain a video material having a target image effect.

13. (canceled)

14. An electronic device, comprising: a memory and a processor; wherein
the memory is configured to store computer program instructions; and
the processor is configured to execute the computer program instructions to enable the electronic device to implement a music creating method, and the music creating method comprises:
exhibiting a plurality of first audio tracks, wherein each of the plurality of first audio tracks are divided into a plurality of candidate track clips according to a timeline, and each of the plurality of candidate track clips corresponds to one audio clip;
determining selected one or more candidate track clips as target track clips and determining that audio clips corresponding to the target track clips are added to positions of the timeline corresponding to the target track clips on the first audio tracks where the target track clips are located, in response to select operations on the one or more candidate track clips among the candidate track clips of the plurality of first audio tracks; wherein the audio clips added onto a plurality of target track clips belonging to a same one of the first audio tracks are the same; and the audio clips added onto the target track clips of different first audio tracks are different; and
sound mixing and synthesizing the audio clips added onto the plurality of first audio tracks according to the timeline, in response to a sound mixing instruction, and playing the same.

15. A readable storage medium, comprising: computer program instructions; wherein
an electronic device executes the computer program instructions to enable the electronic device to implement a music creating method, and the music creating method comprises:
exhibiting a plurality of first audio tracks, wherein each of the plurality of first audio tracks are divided into a plurality of candidate track clips according to a timeline, and each of the plurality of candidate track clips corresponds to one audio clip;
determining selected one or more candidate track clips as target track clips and determining that audio clips corresponding to the target track clips are added to positions of the timeline corresponding to the target track clips on the first audio tracks where the target track clips are located, in response to select operations on the one or more candidate track clips among the candidate track clips of the plurality of first audio tracks; wherein the audio clips added onto a plurality of target track clips belonging to a same one of the first audio tracks are the same; and
the audio clips added onto the target track clips of different first audio tracks are different; and
sound mixing and synthesizing the audio clips added onto the plurality of first audio tracks according to the timeline, in response to a sound mixing instruction, and playing the same.

16. (canceled)

17. The method according to claim 2, further comprising:
adjusting a position range covered by the target track clips comprised in the plurality of first audio tracks on the timeline, and adjusting a tempo of the corresponding audio clips based on an adjusted position range covered by the target track clips on the timeline, so that a duration of the audio clips matches the adjusted position range covered by the target track clips on the timeline.

18. The method according to claim 2, further comprising:
generating and exhibiting a newly added first audio track, in response to a trigger operation on a newly added track control, and determining audio clips respectively corresponding to a plurality of candidate track clips of the newly added first audio track.

19. The method according to claim 3, further comprising:
generating and exhibiting a newly added first audio track, in response to a trigger operation on a newly added track control, and determining audio clips respectively corresponding to a plurality of candidate track clips of the newly added first audio track.

20. The method according to claim 2, further comprising:
deleting a first audio track corresponding to a track deletion control, in response to a trigger operation on the track deletion control.

21. The method according to claim 3, further comprising:
deleting a first audio track corresponding to a track deletion control, in response to a trigger operation on the track deletion control.

22. The method according to claim 4, further comprising:
deleting a first audio track corresponding to a track deletion control, in response to a trigger operation on the track deletion control.
